(19) United States
(12) Patent Application Publication
(10) Pub. No.: US 2006/0025200 A1
(43) Pub. Date: Feb. 2, 2006

(54) Bonus game

(76) Inventor: Shawn Michael Van Asdale, Reno, NV (US)

Correspondence Address: Lena T. Van Asdale, 2573 Rampart Terrace, Reno, NV, 89509, US

(21) Appl. No.: 10/899,992

(22) Filed: Jul. 27, 2004

(51) Int. Cl. A63F 13/00

(52) U.S. Cl. 463/20

(57) ABSTRACT

A computer-controlled electronic gaming device includes a base game, e.g., a set of video reels, and a bonus game, e.g., a mechanical bonus indicator such as a wheel with bonus values arranged in positions thereon and a pointer for indicating one of the positions and its associated bonus value. Upon activation of the bonus game, the gaming device selects at least one of the bonus values by either individually evaluating each successive position on the bonus device against an individually determined probability of stopping at said position or by rendering one or more of the positions ineligible prior to completing the bonus game.

### BACKGROUND OF THE INVENTION

The present invention relates generally to a gaming device and more particularly to a method for controlling a bonus game provided by a gaming device. Gaming devices are devices in which upon a player making a wager, the player may win an award. Gaming devices include machines more commonly referred to as slot machines. There are many types of games that can be played on these gaming devices including but not limited to slots, video poker, keno, bingo, pachinko and blackjack.

Conventional gaming machines typically have a cabinet and a gaming display mounted inside the cabinet. The gaming display may be mechanical, such as a series of stepper reels that carry gaming symbols on the reels, or may be electronic such as a video display that is capable of generating video images of gaming symbols. Whether mechanical or electronic, the gaming display may be capable of generating images associated with a game, such as poker, blackjack, slots, keno, pachinko or bingo.

The gaming device is configured for a player to input something of value, i.e. a wager, which can include a standard denomination of currency, a ticket, and/or any other representation of currency or credit. Once the player inputs a wager, the player may then activate the device. Upon activation, in the case of a slot machine, a plurality of reels which are either mechanical or represented on the video screen spin and ultimately stop to display a random combination of some form of indicia, for example, numbers or symbols. If the display contains one of a plurality of winning combinations, the machine issues an award. The amount of award will often depend on the winning combination that is achieved. The gaming machine then either releases money into a payout chute, issues a ticket, issues credits onto a credit meter, or indicates and awards the winning amount to the player in any suitable manner. Often the award amount is related to the initial amount wagered.

Similarly, with respect to video poker, once a player inputs a wager, a number of cards is displayed and ultimately the player's poker hand ranking is evaluated. With respect to other types of gaming devices discussed above, the appropriate display is shown to the player upon activation of the gaming device and awards are given based on the specific rules of each game.

In some instances the gaming device may offer the player a bonus game. The bonus game may be triggered by the occurrence of a predetermined indicia or combination of indicia in the base game or the bonus game may be triggered by an event, random or otherwise, that is unrelated to the symbols generated in the base game. When the event triggering the bonus game is unrelated to the symbols generated in the base game, it may be desirable to have the probability of triggering the bonus game increase with the amount of the player's wager or some portion thereof. During the bonus game, the player is given an additional award. The bonus award may involve either player interaction or no player interaction. Often a mechanical device or a video representation of a mechanical device is used to indicate the bonus amount. One such device that has become particularly popular is a mechanical device that rotates on an axis to alternately indicate one of several possible bonus amounts. This device may take the form of a wheel (which may include pointers that rotate around a circumference), a bonus reel or reels or the like.

Whether these bonus devices are mechanical or video representations of mechanical devices, today most all such devices are controlled by a microprocessor to provide extended odds as described in U.S. Pat. No. 5,788,573 incorporated herein by reference and as a result, these bonus devices may offer the player the potential to win a very large award, even though the expected value of the bonus game is substantially less than the top award possible. The method described in U.S. Pat. No. 5,788,573 involves mapping each position of the bonus device to a larger number of virtual positions and then randomly selecting one of the virtual positions. Prior to the virtual mapping described in U.S. Pat. No. 5,788,573 mechanical bonus devices such as bonus wheels existed, but did not offer extended odds. One such device was the Monte Carlo slot machine made by Bally Gaming in the 1970's. The bonus wheel on the Monte Carlo had twelve different spots. In one version of this machine, the stop position of the bonus device is chosen by a mechanical randomizer. But because each spot had an equal chance of selection, there were only three values offered—10 (six spots), 20 (four spots) and 50 (two spots)—and the expected value of each spin of the bonus wheel was 20 coins. Because there is little variation between the bottom award, the top award and the average award offered by the Monte Carlo, today's player much rather prefers the mechanical bonuses with extended odds. Thus, bonuses devices that offer the player the opportunity for a large reward add excitement to the game and provide increased enjoyment to the player. It would therefore be desirable to provide alternative methods of controlling these bonus devices to provide the desired outcomes.

### SUMMARY OF THE INVENTION

The present invention achieves the extended odds of a bonus device desired by players by either, alone or in combination, individually evaluating each successive position on the bonus device against an individually determined probability of stopping at said position or by rendering one or more of the positions ineligible prior to completing the bonus spin.

### Individual Evaluation—Embodiment A

In a first preferred embodiment a bonus device may be rotated initially at a relatively high rate of speed and subsequently at a low rate of speed. Once the bonus device reaches the low rate of rotation the player may be able to view and comprehend the positions (and the bonus amount associated with each position) successively indicated by the bonus device. Each position on the bonus device is assigned a probability of success in order to achieve the desired expected value for the bonus spin. As each position is indicated by the bonus device, the gaming machine's processor uses a random number generator to generate a probability number. Thus, for each position indicated, a new probability number may be generated. If the probability number is within the assigned range of probability of success for the indicated position, the bonus device stops. Thereby, indicating to the player the bonus amount won.

### Group Selection 1—Embodiment B

In another alternative embodiment each position of the bonus device is assigned to at least one group such that at least one of the groups has a plurality of positions assigned to it. Each group is then assigned a probability of selection to achieve the desired expected value and a random number generator is used to select one of the groups. All positions associated with that group are then designated as eligible or active positions while those positions that are unassociated with the selected group are designated as ineligible or inactive positions. The bonus device is spun for a random amount of time, where the time of the spin is not intentionally weighted in any attempt to select one position more often than any other position. Once the random amount of spin time is exhausted, the bonus device will stop at the next available active position. Thereby, indicating to the player the bonus amount won.

### Group Selection 2—Embodiment C

In another alternative embodiment, positions on the bonus device are assigned to groups and a single group is selected as before, resulting in the activation and deactivation of various positions. However, rather than selecting a position by spinning the bonus device for a random time and then stopping the bonus device at the next available activated position, each of the active positions is individually evaluated according to the method described in the first embodiment.

### Elimination 1—Embodiment D

In another alternative embodiment, a total bonus amount is chosen at the outset of the bonus game by the gaming machine's random number generator. All possible bonus amounts are weighted to provide the expected value desired by the manufacturer or operator of the gaming device. After the chosen amount is selected, at least all of the positions on the bonus device greater than the chosen amount are deactivated. Other amounts may be deactivated as well as desired. The bonus device then spins and stops on one of the active positions. Any number of known methods can be used to randomly select the indicated position. If the bonus amount associated with the indicated position is less than the original chosen amount, then the difference is used as a new chosen amount. Any additional positions with a value greater than the new chosen amount are deactivated and the player is awarded an additional spin of the bonus device. This iterative process continues until the sum of all of the bonus amounts associated with the indicated positions is equal to the original chosen amount.

### Elimination 2—Embodiment E

In another alternative embodiment, an original chosen amount is initially selected and a first spin of the bonus device is executed as in the fourth embodiment. In this alternative, any difference between the value indicated by the bonus device and the original chosen amount is awarded to the player through an alternative bonus game. This bonus game may relate back to the bonus device by, for instance, multiplying the amount indicated by the bonus device by an integer that will result in a product that equals the original chosen amount. Alternatively, the additional bonus game may be one of the many types of bonus games known as a second screen bonus that provides the player with an award. The award provided by the second screen bonus will preferably be at least the difference between the original chosen amount and the first value indicated.

### BRIEF DESCRIPTION OF THE DRAWINGS

FIG. 1 is a front perspective view of one embodiment of the gaming device of the present invention.

FIG. 2 is a schematic diagram of the electronic configuration of an embodiment of the gaming device of the present invention.

FIG. 3 is a diagram of a bonus device that may be used in one embodiment of the present invention.

FIG. 4 is a table of values, probabilities and expected values that may be used in the individual evaluation method of the present invention.

FIG. 5 is a table of values, probabilities and expected values that may be used in one embodiment of the group selection method of the present invention.

FIG. 6 is a table of values, probabilities and expected values that may be used in one embodiment of the group selection method of the present invention.

FIG. 7 is a table of values, probabilities and expected values that may be used in one embodiment of the elimination method of the present invention.

FIG. 8 is a table of values, probabilities and expected values that may be used in one embodiment of the elimination method of the present invention.

### DETAILED DESCRIPTION OF THE INVENTION

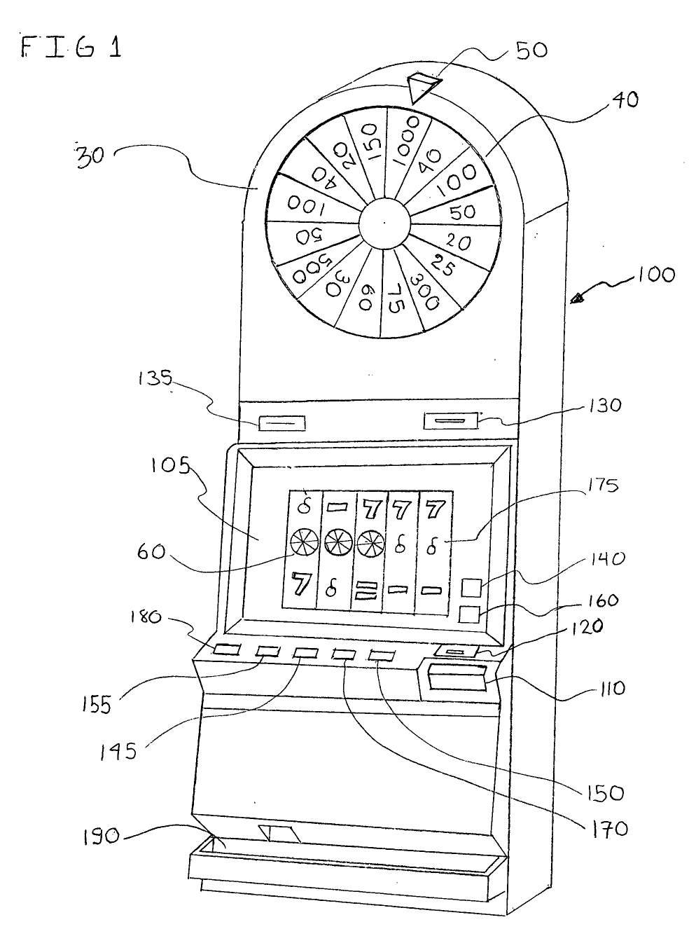

One embodiment of the present invention may be deployed on a gaming device 100 as illustrated in FIG. 1. Gaming device 100 has the features of a conventional slot machine. The gaming device 100 shown in FIG. 1 is what is commonly referred to as an upright slot machine and the player can operate it while standing or sitting. Most often the gaming device 100 is preferably mounted on a cabinet. (Not shown.) Although an up-right slot machine 100 is shown in FIG. 1, it can be appreciated that the gaming device 100 can be any other style of gaming machine known in the art including, but not limited to a pub-style table-top or slant-top game in which a player can operate while sitting. The gaming device 100 can be constructed with varying cabinet and display designs.

Gaming device 100 can incorporate any primary game including, but not limited to slots, video poker, blackjack, keno or bingo. Further, there can be many types of bonus games associated with these primary games. The symbols and indicia used on and in gaming device 100 may be in mechanical, electrical, electronic or video form. Gaming device 100 shown in FIG. 1 has a video display 105 for displaying symbols.

It should be appreciated that the display devices may display any visual representation or exhibition, including but not limited to video images or movement of physical objects such as mechanical reels and wheels. The display devices can be a video monitor or screen, a liquid crystal display or any other display mechanism. Furthermore, it should be appreciated that these display devices may preferably include touchscreens.

As shown in FIG. 1, gaming device 100 includes preferably includes one or more wager accepting mechanisms. The primary wager accepting mechanism on the gaming device 100 shown in FIG. 1 may be a bill validator 110. The bill validator 110 may also accept other forms of payment including, but not limited to tickets, smart cards, debit cards and credit cards. Alternatively, some of these forms of payment may be accepted through a card reader 130. The card reader 130 may include any type of card reading device, such as a magnetic card reader or an optical card reader. The player will insert a card, such as a player tracking card or a credit card into the card reader 130 which will then read data from the card. The card reader 130 may be used to read and/or write from and/or to the inserted card. There is also a coin slot 120 on the gaming device 100 in which a player can insert coins or tokens.

After a player inserts money in the gaming device 100, either via the coin slot 120, the bill validator 110 or the card reader 130, a number of credits corresponding to the amount deposited is shown in a credit display 140. After money is credited to the machine 100 and shown on the credit display 140, the player then determines the wager amount. The machine 100 may have any number of mechanisms known in the art for allowing a player to determine his wager. For example, in the case of a multi-line slot game as shown in FIG. 1, the player may determine the amount of paylines he wishes to wager on by pushing the bet one line button 155 a number of times corresponding to the number of paylines he wishes to bet. Then the player may determine the wager amount per payline by pushing the bet one button 170 an appropriate number of times. The product being the player's total wager. As the player is selecting the wager amount, this wager amount is displayed on a bet display 160. As the bet display 160 amount is incrementing, the credit meter 140 amount is decreasing by the corresponding amount.

Although FIG. 1 displays a five reel video slot machine with three rows of symbols, it can be appreciated that any configuration of video or mechanical reels can be used in the gaming device 100 according to the invention as well as any corresponding number of paylines as known in the art. Each reel often displays symbols or indicia 175. The symbols may include cherries, sevens, bars and the like traditionally used on slot machines or any other symbol created by the manufacturer. The specific display of the symbols 175 after each play determine the payout, if any made by the gaming device 100.

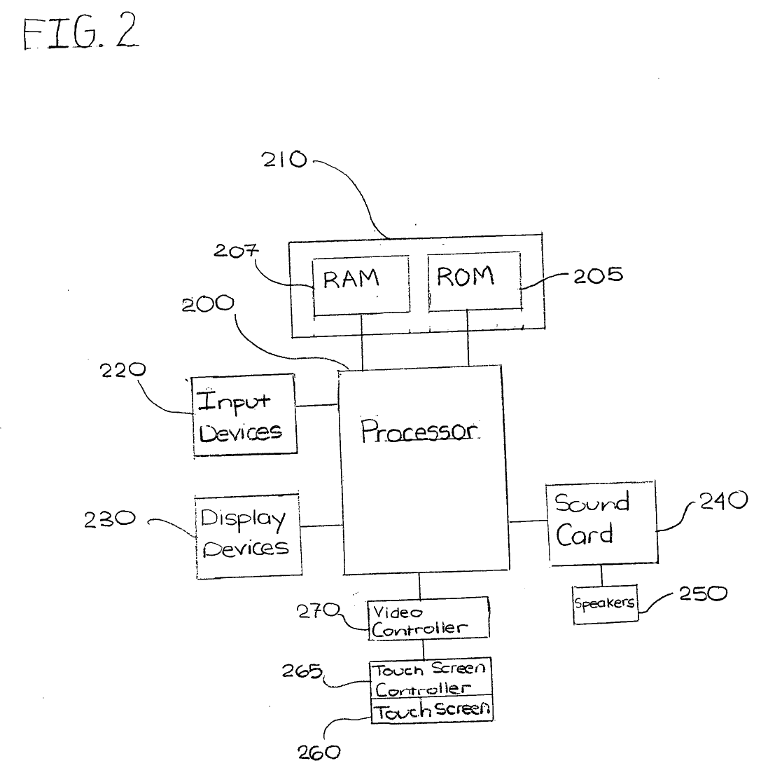

FIG. 2 is a block diagram of the general electronic configuration that may be incorporated in gaming device 100. The configuration preferably includes a processor 200. The processor 200 is preferably a microcontroller-based platform or microprocessor which is capable of displaying images, symbols and other indicia such as images of people, characters, places, things and faces of cards. One or more secondary processors may also be employed in conjunction with the primary processor to control certain aspects of the game function.

The gaming device 100 also includes a memory device 210 for storing program code or other data. This memory device 210 can include both read only memory (ROM) 205 and random access memory (RAM) 207. One of the functions performed by a program or sub-program in the processor 200 may be a random number generator (RNG) using any of several methods known to those skilled in the art. In addition to the memory device 210, the electronic configuration of the gaming device 100 may also include one or more input devices 220, one or more display devices 230, a sound card 240, and one or more speakers 250.

The input devices 220 may include but are not limited to a spin button 145, a bet one credit button 170, a max bet button 150, a cash out button 180 and a bet one line button 155. In situations where a touch screen 260 is used, a touch screen controller 265 and touch screen 260 are connected to a video controller 270 and the processor 200.

Although FIG. 2 shows the processor 200 and memory device 210 residing on the gaming device 100, it should be appreciated that it is possible for both the processor 200 and memory device 210 to reside at a central location instead of at the gaming device 100. In such a situation, a network server may be used to communicate to the gaming device over an Internet connection, local area network (LAN), or wide area network (WAN). The processor 200 and memory device 210 are generally referred to herein as the controller.

Once the player has finalized his wager amount, the player may initiate play by pressing the spin button 145. In response to play initiation, the gaming device 100 randomly displays a plurality of symbols 175 on the video display 105. In the video configuration of the gaming device 100 shown in FIG. 1, the symbols 175 are displayed by simulating the spinning of the video reels. The processor 200 evaluates the displayed symbols 175 on the selected paylines to determine if any winning combinations occurred. For each winning combination the credit meter 140 is incremented a predetermined amount.

In addition to winning credits on the “base game” or primary game in this manner, the gaming device 100 also gives players the opportunity to win credits in a bonus game. The bonus game may primarily be displayed to the player using a bonus device 30. Preferably bonus device 30 is a mechanical device comprising a wheel 40. The wheel 40 is divided into several areas. In a preferred embodiment each area is associated with a bonus amount. The bonus device also comprises a means for indicating at least one of the areas 14. In the gaming device 100 shown in FIG. 1, a pointer 50 indicates one of the areas 14 on the wheel 40. It can be appreciated that a wheel is one of many embodiments for this bonus device, but that any mechanical bonus device or video representation of a bonus device in which values are displayed to the player can be used.

In an embodiment of the present invention, the gaming device 100 initiates a secondary or bonus game if a player achieves a bonus triggering or qualifying condition during play of the primary game. The bonus triggering or qualifying event can be a bonus initiation symbol 60 landing on a payline or multiple bonus initiation symbols 60 lining up in a certain pattern or in a “scatter” pattern on the gaming device 100 during play. Other bonus initiators, such as, but not limited to the initiator described in Australian Patent Application Nos. 2001100032 and 2001100033, incorporated herein by reference, are known in the art and may be used as well.

Once the bonus game is initiated by any bonus-triggering event known in the art, the gaming device 100 indicates to the player that the bonus has been initiated. The player may then be instructed to initiate the bonus by pressing the spin button 145. Alternatively, a special bonus initiating button (not shown) may be provided either in a mechanical form or as a touchscreen button. Also, in one preferred embodiment, the bonus will be initiated automatically after the player achieves the bonus trigger without further player involvement.

After the player initiates the bonus or in the case of a self-initiating bonus, after a desired amount of time passes, the wheel 40 begins to spin. The processor 200 is operatively connected to the wheel 40 preferably by a stepper motor or by any other means known by those in the art. This operative connection not only allows the processor 200 to initiate the spinning of the wheel 40, but also allows the processor 200 to monitor the wheel's position while it is being spun and to stop the wheel 40 at any desired position, the stop position. The stop position of the wheel 40 is determined in accordance with one of the embodiments described below. Once the wheel 40 stops the pointer 50 indicates a value that the player has won as a result of the activation of the bonus device 30. The value indicated is awarded to the player and the credit meter 140 may be incremented accordingly. The gaming device 100 may continue to provide an additional bonus game to the player using either the bonus device 30 or another form of bonus know in the art or it may return to normal operation.

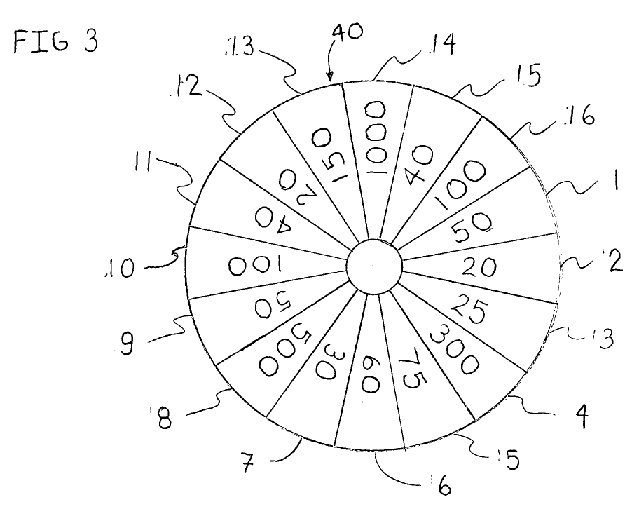

Referring now to FIG. 3, the wheel 40 has been divided into sixteen areas numbered 1 to 16. Each area has one bonus value ranging from 20 to 1000. These bonus amounts may be gross credit amounts awarded to the player if the bonus area is selected or may be amounts that are multiplied by the number of credits bet per line, the number of lines bet or any combination thereof, including the total amount wagered.

### Individual Evaluation—Embodiment A

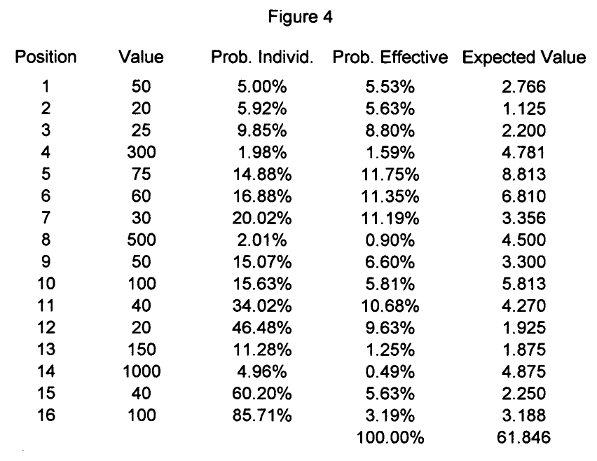

FIG. 4 illustrates the first embodiment according to the present invention, referred to generally as individual evaluation. In this embodiment, each of the sixteen areas of the bonus wheel 40 is assigned an individual probability of success shown on FIG. 4. For instance, as indicated in FIG. 4, the area containing the 300 credit bonus amount 4, has an individual probability of success of 1.98% while the area containing the 30 credit bonus amount 7, has an individual probability of success of 20.02%.

As the wheel 40 is spinning the processor 200 monitors which of the wheel's areas is currently being indicated by the pointer 50. As the wheel 40 is spinning, the processor 200 generates a series of random numbers between 0 and 1 using the RNG. Preferably, exactly one random number is generated each time a new area is indicated on the wheel 40. The most recent random number generated is then compared to the individual probability associated with the area currently being indicated. If the random number is equal to or less than the individual probability (i.e., a successful trial), the processor 200 will stop the wheel 40 at the current position.

Because the processor 200 is evaluating each area of the wheel 40 on an individual basis, it may be preferable to spin the wheel 40 at a sufficiently slow speed. A relatively low speed also has the added benefit of allowing the player to comprehend which area of the wheel 40 is being indicated at any given time. In one preferred embodiment the speed of the wheel 40 is reduced incrementally after each unsuccessful trial. In addition, it may be desirable to initially spin the wheel 40 at a high rate of speed where no trials are being attempted. This portion of the spin where no trial is attempted is provided primarily for the amusement of the player and may last for a random or predetermined amount of time or number of rotations. In the preferred variation of this embodiment, the first trial is always attempted on the same reference position, arbitrarily position 1. In an alternative variation, the first position to be tried may be randomly selected after the wheel 40 is spun for an initial period.

The mathematical properties represented by FIG. 4 represent the previous variation where the first trial is always performed on a first reference point. Therefore, the probability of the bonus device 30 stopping the wheel 40 at the first area 1 on the first attempt is 5%. The probability of the bonus device 30 stopping the wheel 40 at the second area 2 on the second attempt can be calculated as the probability of an unsuccessful previous trial (95%) times the individual probability of the second area 2 (5.92%). This yields an effective probability of 5.63% for the second area 2. The effective probability listed on FIG. 4 is the probability of each area and corresponding bonus amount being selected prior to the initiation of the bonus device 30. Based on the individual probabilities in FIG. 4, there is a 0.53% chance that the wheel 40 will proceed through all sixteen areas without the processor 200 choosing a random number that yields a successful trial. In the embodiment shown, the wheel 40 will be stopped without generating a random number the second time the wheel 40 reaches the first area 1. Alternatively, if there is no successful trial after the first full rotation, the wheel 40 may continue to spin and individually perform trials to determine where to stop. The individual stop probabilities used for this second rotation of the wheel may be the same or different than the individual probabilities used on the first rotation.

As can be seen in FIG. 4, the effective probabilities for the higher value awards on the wheel 40 are significantly less than 1/16. Multiplying each award associated with a position by that position's effective probability yields the expected value for each individual position. By summing up these expected values for all positions, as shown in the last column of FIG. 4, the total expected value for a given spin of the wheel 40 is 61.85 credits.

### Group Method—Embodiments B & C

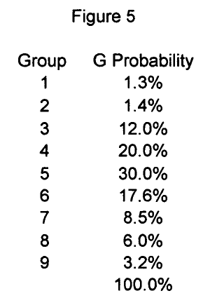

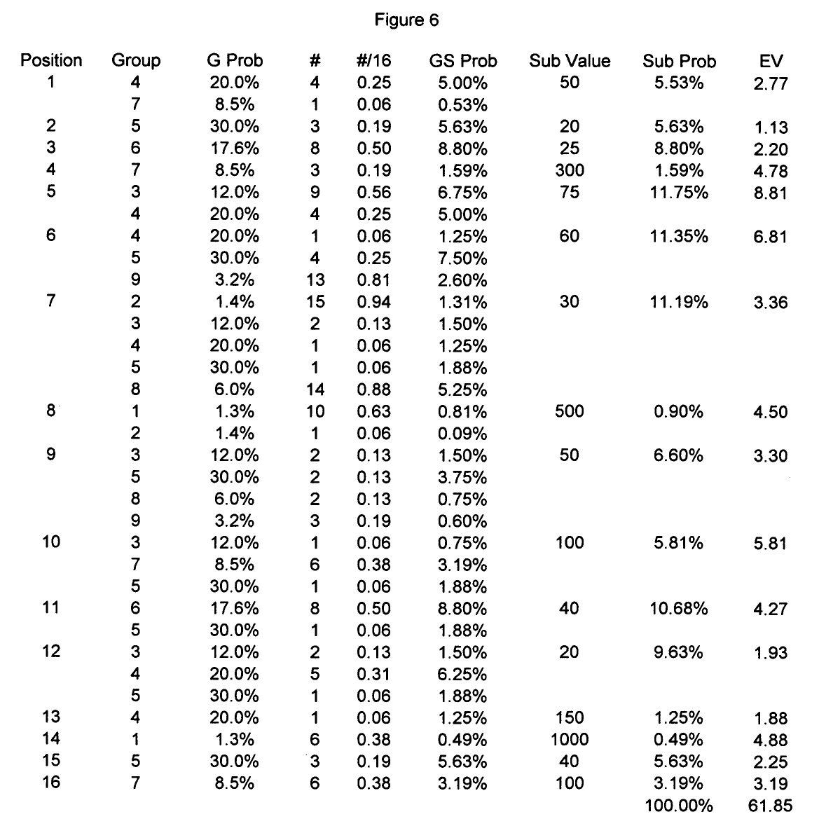

Referring now to FIGS. 5 and 6, embodiments B and C of the invention will now be described in detail. These embodiments are generally referred to as the group method of selection. Referring first to FIG. 5, nine groups have been defined and each group has been assigned a group probability. Referring now to FIG. 6., each position on the wheel 40 has been assigned to at least one, and for some positions more than one, group.

As an initial step in the play of the bonus game, the RNG is used to select one group according to the predefined group probabilities. The positions that have been assigned to the selected group are then designated as active positions while the remaining positions that are not in the selected group are designated as inactive positions. Inactive positions cannot be selected on the subsequent spin of the wheel 40.

In the first variation of the group method (i.e., embodiment B), the wheel 40 may be rotated in preferably 3 modes. In the first mode, as in embodiment A, the wheel 40 may be spun at a relatively high rate of rotation and there is no attempt to stop the wheel 40. This first mode is not essential, but is mainly used to entertain the player and “set” the wheel 40. In the second mode of rotation the wheel 40 spins for a random amount of time. The precise amount time is preferably chosen by processor 200 using its RNG. Preferably, no attempt is made to determine the ultimate stop position of the wheel 40 during this second mode. Similarly, no attempt is made to provide enhanced odds to the bonus device 30, at this time. The speed of rotation of the wheel 40 preferably changes from the initial velocity, to a slower second velocity during the second rotation mode. This change in speed may be abrupt or gradual. When the random time has expired, the wheel 40 enters the third mode of rotation. In the third mode, the wheel 40 stops when the pointer 50 indicates the next active position as determined by the previously selected group. Again the speed of rotation may decrease during the third mode in either an abrupt or gradual manner.

In the preferred variation of embodiment B, there is an equal probability that each of positions on the wheel 40 will be the indicated position when the bonus device 30 exits the second mode. Thus, the relative probability for each position in a given group can be calculated as a fraction with a numerator equal to one plus the number of inactive positions between a given active position and the next active position in the opposite direction of rotation and a denominator equal to the total number of positions on the wheel 40. Referring again to FIG. 6, the numerator for this fraction for each position as a function of its group is indicated in the fourth column and the fraction is in column five. Multiplying the fraction by the group probability yields an individual probability for a given group as shown in column six. Summing up all of these probabilities for a given position yields the total effective probability for any given position as shown in column eight. Multiplying the effective probability for each position by the award value yields the expected value as shown in column nine. Summing up all of the expected values yields the total expected value for a given spin of the wheel 40. As shown in FIG. 6 the effective probabilities and expected values for the exemplar group selection method has been matched to the same values derived in FIG. 4 using the individual evaluation method even though markedly different methods for achieving these results were used.

The main difference between embodiment B and embodiment C occurs when the spin enters the third mode. In embodiment C, upon entering the third mode, rather than automatically stopping the wheel 40 on the next active position, the processor 200 will cause the wheel 40 to proceed to the next active position and will perform an individual evaluation on the position using the predetermined individual probability associated with the position as exemplified in embodiment A. If this trial is unsuccessful, the wheel 40 will proceed to the next active position and again perform an individual trial. This process will continue until one of the positions in the group is chosen through a successful trial.

Referring now to FIGS. 3, 5 and 6 an example of how a bonus device 30 utilizing embodiment B of the present invention will now be described. As an initial step, the RNG in the processor 200 may produce the number 0.200. Referring then to FIG. 5, this will equate to a selection of Group 4. Referring to FIG. 6, the positions in Group 4 are 1, 5, 6, 7, 12 and 13. These positions will be designated as active. The remaining positions are deactivated. Next assume that the wheel 40 spins in a clockwise direction for a random amount of time before entering mode 3. When the bonus device 30 enters mode 3, the pointer 50 is indicating position 8 on the wheel 40. The wheel 40 keeps rotating until the pointer 50 indicates the next active position, which is position 12. Position 12 has a value of 20. Therefore, 20 credits is awarded to the player.

### Elimination Method—Embodiments D & E

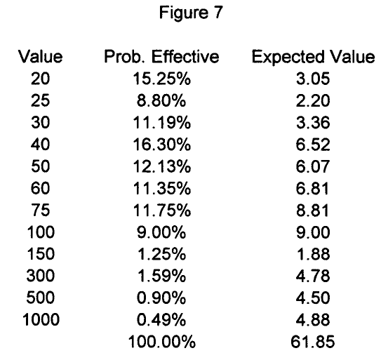

In another embodiment, after the processor 200 has determined to award the player a bonus by activating the bonus device 30, the processor 200 uses its RNG to determine a maximum bonus award amount, Bmax. The maximum bonus award amount is the total amount that will be awarded to the player. The selection of Bmax is made using enhanced odds in any one of several manners well known in the art. As an example, FIG. 7 shows possible associated probabilities for the selection of Bmax. After Bmax is chosen, all positions with corresponding bonus values greater than Bmax on the wheel 40 are designated as inactivate. Additionally, other positions may also be deactivated for reasons that will be made clear later in the description.

In the first variation of the elimination method, embodiment D, once the positions on the wheel 40 with values greater than Bmax are designated as inactive, the processor 200 will cause the bonus device 30 to indicate a first position, chosen from the remaining active positions. The bonus amount associated with the first selected position is designated as Bfirst. If Bfirst is less than Bmax, the player will be awarded another activation of the bonus device 30. In the next activation of the bonus device 30, additional positions on the bonus device 30 will be designated as inactive, such that any position with a value greater than the difference between Bmax and Bfirst is inactive. Other positions may also be deactivated. This iterative process will continue n times until the sum of Bfirst to Bnth is equal to Bmax. After each iteration additional positions will be deactivated.

Each additional activation of the bonus device 30 can be presented to the player in any number of ways. It may just be presented to the player as a gratuitous extra “lucky” spin or the player may play an intermediary game to “earn” the extra spin. For instance, the player may be asked to guess if the next card off of a virtual deck of cards is going to be red or black. Each time the player guesses correctly, he will be awarded an extra activation of the bonus device 30. The player will “guess” correctly until such time as the player's total awards from the bonus device 30 total Bmax. After this time, the player will guess incorrectly. Alternatively, the player may push a button to flip a virtual “lucky coin” with one side marked “Spin Again” and the other side marked “Bonus Over.”

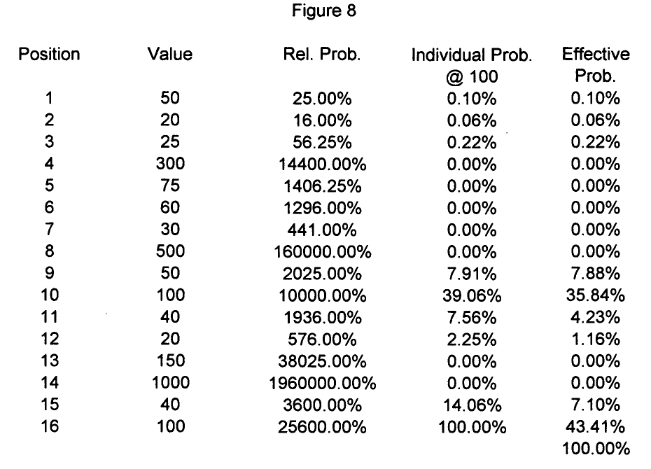

The actual stop position of the bonus device 30 can be selected in any number of ways. For instance, the stop position may be determined using the individual evaluation method as described in embodiment A. When individual evaluation is used, it is preferable that the individual probabilities of each stop position will be proportionally related to the value of the position, such that stop positions with higher values will generally have a higher individual probability. Once at least the positions with a value higher than the maximum allowed value for each spin are eliminated, the individual probabilities of the active positions will preferably be normalized such that the highest active value has an individual probability near 90%. Referring now to FIG. 8, the initial relative individual probabilities of each position is indicated in column 3 of the table. These initial probabilities are based on the square of the position number multiplied by the square of the position's bonus amount divided by 10,000. Assuming that Bmax has been set at 100, the normalized individual probabilities for the first activation of the bonus device 30 are shown in column 4 of FIG. 8.

Alternatively, the actual stop position of the bonus device can be determined by using a random spin time to select the first available stop position as was performed for embodiment B. In this alternative, the wheel 40 spins for a random amount of time upon the activation of the bonus device 30. As in previous embodiments, the activation of the bonus device 30 may either be automatic or in response to some player interaction, e.g., the depressing of the spin button 145. Also as in previous embodiments, the spinning of the wheel 40 can be choreographed in any number of ways to entertain the player and increase the anticipation of the bonus event. This may preferably include initially spinning the wheel 40 at a relatively high rate of speed and then later slowing it to indicate that it will soon stop. This change in speed may also be accompanied by audible indications that the wheel 40 will soon stop. As in previous embodiments, the amount of time for which the wheel 40 spins is not chosen in any particular effort to cause the wheel 40 to stop spinning so as to indicate any particular position on the wheel 40. Once the random amount of time has passed, the processor 200 will stop the wheel 40 at the next active position.

For example, assume that the RNG selects a bonus award amount Bₘₐₓ=50. Upon activation of the bonus device 30, the wheel 40 spins in a clockwise direction. When the random amount of time has passed, the pointer 50 is indicating position 6, which in this example corresponds to a bonus amount of 60. Therefore, this is an inactive position. The wheel 40 keeps spinning until the pointer 50 indicates the next active position. In this example, as the wheel 40 is spinning in a clockwise direction, the next position which is less than Bₘₐₓ, i.e., 50, is position 3. Position 3 has an associated value of 25. Once the wheel 40 stops at position 3, the player will be awarded another spin where the only active position will preferably be position 3. Note that positions 2 and 12 could also be active, but if these positions (with a value of 20) were selected, there would be no position on the wheel 40 that could award the remainder of 5 bonus credits.

In embodiment E, another alternative embodiment of the elimination method, Bmax and the initial result of the bonus device 30 are chosen as before. However, if there is a difference between the initial result and Bmax, the player is not necessarily awarded another activation of the bonus device 30. Rather, the difference between Bmax and the initial award amount is provided to the player by awarding an additional bonus amount that does not require a second activation of the bonus device 30. This additional amount may be provided to the player by playing, for instance, a bonus game commonly known as a second screen bonus. One such second screen bonus that is well known and widely utilized in the gaming industry is described in U.S. Pat. Nos. 6,089,976; 6,015,346; 6,261,177 and 6,190,255, incorporated herein by reference. Also, it is not necessary that the player actually play a secondary bonus game at all to receive the additional amount. In one alternative embodiment, following the activation of the bonus device 30, the gaming device 100 may simply inform the player that in addition to the initial amount, the player will be awarded “X” credits, where X is the difference between Bmax and the initial amount.

1. A gaming device comprising:
a wager accepting mechanism;
a device for allowing a player to select a wager amount;
a plurality of reels, each of said reels having at least one symbol thereon;
a movable mechanical bonus device with a plurality of regions, said bonus device being activatable following a triggering event, wherein each of said regions on said bonus device has a probability of success associated with said region and at least one of said regions has a bonus amount associated with it;
a processor operatively connected to the wager accepting mechanism, the wagering device, the plurality of reels and the bonus device, said processor having a memory and being programmed to spin the reels in response to a player placing a wager, said processor being further programmed to stop the reels at a position selected by a random number generator;
said processor causing said bonus device to sequentially indicate said regions upon activation and said processor generating a random number using the random number generator each time the next region in sequence is indicated, said processor comparing the random number against the probability of success of the indicated region and stopping said bonus device at the finally indicated region upon a successful trial; said processor awarding the player the bonus amount, if any, associated with the finally indicated region.

2. A gaming device as defined in claim 1 wherein the bonus device comprises a wheel rotating about an axis with the regions arranged on the circumference of the wheel and indicated by a pointer.

3. A gaming device as defined in claim 2 wherein the triggering event is the occurrence of one or more symbols on at least one of the reels of the gaming device.

4. A gaming device as defined in claim 3 wherein the triggering event requires the occurrence of a combination of symbols on a plurality of the reels of the gaming device.

5. A gaming device as defined in claim 2 wherein the triggering event is unrelated to the outcome of the reels, but is randomly determined based proportionately upon the wager made by the player, or a portion of the wager made.

6. A gaming device as defined in claim 3 wherein one region on the wheel is designated as a reference position and upon activation of the wheel the wheel begins to rotate so as to indicate a plurality of regions, but the processor does not compare the random number to the probability of success for any indicated region until the reference position is indicated.

7. A gaming device as defined in claim 6 wherein the processor causes the wheel to complete more than a full rotation before the processor compares the random numbers generated to the individual probabilities of success.

8. A slot machine comprising:
a housing having a front portion;
a device for accepting currency or another indicator thereof;
a device for allowing a player to select an amount to be wagered;
a plurality of reels, each of said reels having at least one symbol thereon;
a movable mechanical bonus device with a plurality of regions, said bonus device being activatable following a triggering event, wherein each of said regions on said bonus device is assigned to at least one group of regions such that there are a plurality of groups and each group has a probability of success associated with it and at least one of said regions has a bonus amount associated with it;
a processor operatively connected to the currency accepting device, the wagering device, the plurality of reels and the bonus device, said processor having a memory and being programmed to spin the reels in response to a player depositing currency in the slot machine and selecting an amount to be wagered, said processor being further programmed to stop each reel at a position selected by a random number generator;
in response to a triggering event, said processor using a random number to select one of said groups, said processor designating each of said regions in said selected group as an active region and designating each of said regions not in said selected group as an inactive region;
said processor causing said bonus device to activate and to randomly stop on an active region; said processor awarding the player the bonus amount, if any, associated with the selected active region.

9. A slot machine as defined in claim 8 wherein the bonus device comprises a wheel rotating about an axis with the regions arranged on the circumference of the wheel and indicated by a pointer.

10. A slot machine as defined in claim 9 wherein the triggering event is the occurrence of one or more symbols on at least one of the reels of the slot machine.

11. A slot machine as defined in claim 10 wherein the triggering event requires the occurrence of a combination of symbols on a plurality of the reels of the slot machine.

12. A slot machine as defined in claim 9 wherein the triggering event is unrelated to the outcome of the reels, but is randomly determined based proportionately upon the wager made by the player, or a portion of the wager made.

13. A slot machine as defined in claim 10 wherein the processor randomly determines an amount of time for the wheel to spin and at the expiration of this time the processor stops the wheel at the next active region.

14. A slot machine as defined in claim 10 wherein each of said regions on said bonus device has a probability of success associated with said region and said processor causes said bonus device to sequentially indicate said regions and said processor generates a random number using the random number generator each time the next region in sequence is indicated if said region is an active region, said processor comparing the random number against the probability of success of the indicated region and stopping said bonus device at the finally indicated region upon a successful trial.

15. A slot machine comprising:
a housing having a front portion;
a device for accepting currency or another indicator thereof;
a device for allowing a player to select an amount to be wagered;
a plurality of reels, each of said reels having at least one symbol thereon;
a movable mechanical bonus device with a plurality of regions, said bonus device being activatable following a triggering event, wherein at least one of said regions has a bonus amount associated with it;
a processor operatively connected to the currency accepting device, the wagering device, the plurality of reels and the bonus device, said processor having a memory and being programmed to spin the reels in response to a player depositing currency in the slot machine and selecting an amount to be wagered, said processor being further programmed to stop each reel at a position selected by a random number generator;
the memory of said processor containing a table of possible bonus values and probabilities associated with each bonus value;
in response to a triggering event, said processor using a random number to select a maximum bonus value from the table of possible bonus values, said processor designating at least each of said regions with a bonus value greater than the maximum bonus value as an inactive region and designating at least one of the remaining regions as an active region;
said processor causing said bonus device to activate and to randomly stop on an active region; said processor awarding the player the bonus amount, if any, associated with the selected active region.

16. A slot machine as defined in claim 15 wherein the bonus device comprises a wheel rotating about an axis with the regions arranged on the circumference of the wheel and indicated by a pointer.

17. A slot machine as defined in claim 16 wherein the triggering event is the occurrence of one or more symbols on at least one of the reels of the slot machine.

18. A slot machine as defined in claim 17 wherein the triggering event requires the occurrence of a combination of symbols on a plurality of the reels of the slot machine.

19. A slot machine as defined in claim 16 wherein the triggering event is unrelated to the outcome of the reels, but is randomly determined based proportionately upon the wager made by the player, or a portion of the wager made.

20. A slot machine as defined in claim 17 wherein following the initial selection of an active region, the processor designates additional regions as inactive, said additional regions including at least those regions that have a bonus amount greater than the difference between the maximum bonus amount and the initially selected active region; and wherein the wheel is activated a second time so as to select a second active region.

21. A slot machine as defined in claim 20 wherein the processor continues to deactivate regions and select additional regions until such time as the sum of the bonus values associated with the selected regions totals the maximum bonus amount.

22. A slot machine as defined in claim 17 wherein the processor is programmed to initiate a secondary bonus game that does not involve the bonus device so as to provide the player with at least a secondary bonus amount following the selection of the initial active region, wherein the secondary bonus amount awarded is based upon the difference between the maximum bonus amount and the bonus amount associated with the active region initially selected.
